(19) United States
(12) Patent Application Publication
(10) Pub. No.: US 2018/0137425 A1
(43) Pub. Date: May 17, 2018

(54) REAL-TIME ANALYSIS OF A MUSICAL PERFORMANCE USING ANALYTICS

(71) Applicant: International Business Machines Corporation, Armonk, NY (US)

(72) Inventors: Salvatore D'Alo', Roma (IT); Marco Lerro, Roma (IT); Mario Noioso, Roma (IT); Nicola Piazza, Roma (IT)

(21) Appl. No.: 15/354,363

(22) Filed: Nov. 17, 2016

(51) Int. Cl. G06N 5/04; G06K 9/00

(52) U.S. Cl. CPC G06N 5/04; G06K 9/00302; G10H 2210/091; G06K 9/00973; G06K 9/00335

(57) ABSTRACT

A method and associated systems for real-time analysis of a musical performance using analytics. A performance-analysis system receives feedback from which may be inferred an audience's reaction to the performance. This feedback may be derived from sensors embedded in instruments or microphones, from video-input devices that visually represent the audience's body language and facial expressions, and from performance ratings and natural-language comments submitted by audience members to a social-media network or performance-rating application. An analytics engine of the performance-analysis system uses methods of artificial intelligence to infer the audience's emotional state from the received feedback and to determine whether certain characteristics of the performance are undesirable. The system represents these inferences as a value of a performance index and represents the index value to the performers. The system may also make specific recommendations deemed likely to reduce undesirable performance characteristics during the remainder of the performance.

### BACKGROUND

The present invention relates to electronic analysis of a musical, dramatic, visual, or other type of performance and, in particular, to using methods of machine learning, analytics, or other forms of artificial intelligence to provide real-time feedback to a performer capable of allowing the performer to respond while the performance in progress, allowing performing artists, like musicians, actors, visual artists, stand-up comedians, and other types of professional, student, or rehearsing performers to alter their performances on-the-fly in response to an audience's reaction or to a report of performance errors.

An undetectable performance problem may occur when a performer is unable to fully understand an audience reaction quickly enough to address the problem. For example, if an audience is unenthusiastic about a vocalist's request to join a sing-along, some audience members may still participate. The performer may thus be unable to tell whether the audience is enjoying the opportunity. Similarly, a dance troupe, acting company, or multimedia-performance artist capable of connecting emotionally with an audience in a small venue, may have difficulty judging listener sentiment in a large hall, where many audience members are not easily visible from the stage.

Similar issues arise when a professional or student performer or artist rehearses in private. Without benefit of audience feedback, for example, a practicing pianist may not realize that performance errors in tempo, timing, pitch, dynamics, or timbre make the pianist's performance less compelling.

There is thus a need for a method to provide real-time feedback to performing artists, either during a public performance or during a practice session, and either by detecting and analyzing characteristics of an audience's reaction, or by analyzing the performance itself to identify performance errors.

### BRIEF SUMMARY

An embodiment of the present invention provides a real-time performance-analysis system comprising a processor, a memory coupled to the processor, one or more sensors coupled to the processor and embedded into musical instruments used by performers of a musical performance, a network interface that connects the processor to a computer network, and a computer-readable hardware storage device coupled to the processor, the storage device containing program code configured to be run by the processor via the memory to implement a method for real-time analysis of a musical performance using analytics, the method comprising:

the processor electronically receiving real-time feedback characterizing an ongoing musical performance by one or more performers;

the processor inferring a characteristic of the performance by using an artificially intelligent analytics procedure to analyze the real-time feedback,

where the analytics procedure is a function of a repository of archived information about past performances by the one or more performers and of a knowledgebase from which the feedback may be given semantic meaning, and

where the inferred characteristic is considered undesirable by the one or more performers; and

the processor communicating the inferred characteristic to the one or more performers for the purpose of allowing the one or more performers to alter their ongoing performance in order to mitigate undesirability of the inferred characteristic.

Another embodiment of the present invention provides method for real-time analysis of a musical performance using analytics, the method comprising:

a processor of a real-time performance-analysis system electronically receiving real-time feedback characterizing an ongoing musical performance by one or more performers;

the processor inferring a characteristic of the performance by using an artificially intelligent analytics procedure to analyze the real-time feedback,

where the analytics procedure is a function of a repository of archived information about past performances by the one or more performers and of a knowledgebase from which the feedback may be given semantic meaning,

where the inferred characteristic is considered undesirable by the one or more performers, and

where the inferring further comprises a determination that a modification to the performance of at least one performer of the one or more performers during the remainder of the ongoing performance is likely to mitigate the undesirability of the characteristic; and

the processor communicating the inferred characteristic to the one or more performers for the purpose of allowing the one or more performers to alter their ongoing performance in order to mitigate undesirability of the inferred characteristic,

where the communicating comprises recommending the modification to the at least one performer.

Yet another embodiment of the present invention provides a computer program product, comprising a computer-readable hardware storage device having a computer-readable program code stored therein, the program code configured to be executed by a real-time performance-analysis system comprising a processor, a memory coupled to the processor, one or more sensors coupled to the processor and embedded into musical instruments used by performers of a musical performance, a network interface that connects the processor to a computer network, and a computer-readable hardware storage device coupled to the processor, the storage device containing program code configured to be run by the processor via the memory to implement a method for real-time analysis of a musical performance using analytics, the method comprising:

the processor electronically receiving real-time feedback characterizing an ongoing musical performance by one or more performers;

the processor inferring a characteristic of the performance by using an artificially intelligent analytics procedure to analyze the real-time feedback,

where the analytics procedure is a function of a repository of archived information about past performances by the one or more performers and of a knowledgebase from which the feedback may be given semantic meaning, and

where the inferred characteristic is considered undesirable by the one or more performers, and

where the inferring further comprises a determination that a modification to the performance of at least one performer of the one or more performers during the remainder of the ongoing performance is likely to mitigate the undesirability of the characteristic; and

the processor communicating the inferred characteristic to the one or more performers for the purpose of allowing the one or more performers to alter their ongoing performance in order to mitigate undesirability of the inferred characteristic,

where the communicating comprises recommending the modification to the at least one performer.

### BRIEF DESCRIPTION OF THE DRAWINGS

FIG. 1 shows the structure of a computer system and computer program code that may be used to implement a method for real-time analysis of a musical performance using analytics in accordance with embodiments of the present invention.

FIG. 2 is a flow chart that illustrates the steps of a method for real-time analysis of a musical performance using analytics in accordance with embodiments of the present invention.

FIG. 3 illustrates an architecture of an embodiment of the present invention in which the analytics engine receives real-time objective performance data from sensors embedded in musical instruments.

FIG. 4 illustrates an architecture of an embodiment of the present invention in which the analytics engine receives real-time visual data representing body language or facial expressions of audience members.

FIG. 5 illustrates an architecture of an embodiment of the present invention in which the analytics engine receives real-time ratings of a performance submitted by audience members through personal computing devices.

### DETAILED DESCRIPTION

The present invention comprises methods and associated systems for using methods of analytics to analyze elements of a musical, visual, or other type of artistic performance and, in response, provide real-time feedback to a performer. This real-time feedback allows performing artists like musicians, visual artists, stand-up comedians, actors, and other types of professional or student performers, to alter their manner of performance on-the-fly in response to an audience's reaction.

Embodiments of the present invention automatically gather information about a performance, and about an audience's reactions to the performance, from one or more distinct sources, and then submit the gathered information to an artificially intelligent analytics engine that, optionally referring to an AI knowledgebase or to a database of historic performance data, identifies specific problems with the performance. These problems may be associated with objective performance data collected from “smart” musical instruments, microphones, stage monitors, or other content-generating entities, that contain embedded sensors. Such objective data might, for example, identify errors in a musical improviser's choices of note pitch, tempo, rhythm, or harmony, or an error in a practicing musician's attempt to play a musical score.

In other cases, these problems may be identified as a function of an audience member's undesirable body language or facial expression, or as a function of an audience's real-time ranking or comments submitted to a remote software application or Web site by means of personal or mobile computing or communications devices.

In some embodiments, the analytics engine may base its inferences on combinations of three types of feedback: sensor data, audience sentiment inferred from visual representations of audience members' voluntary or involuntary body language or facial expressions, and consciously entered audience ratings and comments.

In response to identifying objective performance errors, audience sentiment, or audience ratings and comments, the system may notify the performers of any other desirable, undesirable, positive, or negative inferences, and may make specific recommendations deemed likely to mitigate any undesirable effects.

For example, a rock guitarist may play a guitar into which a sensor is embedded, in an auditorium equipped with cameras capable of transmitting visual representations of audience body language and facial expressions to the performance-analysis system, and where audience members carry smartphones capable of sending “Like” and “Dislike” ratings to an Internet Web site or cloud-based ratings service.

As the guitarist plays, any of these feedback mechanisms may continuously transmit feedback data, through a communications interface and a software module that receives, aggregates, formats, or organizes incoming feedback, to an analytics engine of a real-time performance-analysis system. As the analytics engine infers or otherwise identifies errors, negative sentiments, and unfavorable ratings, the system may, through a reporting module, represent the inferred or identified concepts to the guitarist in any way known in the art. These reporting methods may comprise displaying a textual, numeric, graphical, video, or animated representation of errors on a monitor, illuminating an LED indicator on the guitar or worn on the guitarists clothing, or by other known methods that may comprise haptic, audio, or visual feedback.

If, in the current example, the guitarist is expected to play a melody at a particular tempo, or to play a note that should synchronize or harmonize with other players' parts, an LED on the neck of the guitar may light up green if the part is played correctly, flash yellow if the guitarist's tempo begins to waver, or turn red if the guitarist plays a wrong note.

In some embodiments, the analytics engine may, by means of known methods of artificial intelligence, make specific performance recommendations to a performer with the intent of allowing the performer to reduce the current undesirability of an audience's reaction. For example, if, at a dramatic performance, audience facial expressions reveal increasingly unfavorable reactions at the same time that a sensor embedded into a stage microphone reports that one actor is speaking too softly to be heard, the system might respond with a visual, audio, or verbal suggestion that the actor increase his volume. This communication might be made to the actor through any means known in the art, such as via an earpiece, a floor speaker, a display of a computing device, or an LED indicator.

In other embodiments, rather than making specific remedial recommendations, the system may display an alphanumeric “performance index” that identifies an instantaneous aggregated or average audience sentiment inferred from audience body language, facial expressions or textual comments; an average performance accuracy derived as a function of the objective performance parameters; an average audience rating; or combinations thereof. This index may be displayed as a continuously varying number, as an animated or still graphical representation of a numeric performance index, or in any other form known in the art. In some cases, an indicator may alert a performer only when the current performance index value exceeds or falls below a predetermined threshold value, or when some other condition occurs, such as a low performance-index rating persisting for a duration of time deemed to be unacceptable.

In other examples, the analytics engine may draw other inferences by integrating multiple types of feedback. If the system used by a dance band determines that audience members have remained in their seats for four minutes and further determines that the band has been playing at a 20%-slower tempo for five minutes, the analytics engine might recommend that the band increase its tempo.

Similarly, in a performance of a visual performing artist, if cameras detect audience members squinting, and an Internet-based ratings system determines that user feedback has abruptly stopped, the analytics engine might infer that the artist has displayed an image that is bright enough to blind the audience. In response, the system might alert the artist to reduce the brightness of her projector.

In all cases, the system may perform these procedures in real time, or quickly enough to provide feedback or suggestions to a performer that allow the performer to adjust a characteristic of an ongoing performance on-the-fly.

More specifically, this document uses the term “real-time” response to describe a system response time short enough to enable feedback to be displayed to a performer at substantially the same time as the performance activity that is the subject of the feedback. “Real-time” response may also include what is commonly termed “near real-time” response, generally meaning a time frame of sufficiently short duration as to provide a response time for on-demand information processing acceptable to a user of the described subject matter (such as a duration of less than a second or, at worst, of no more than a few seconds). These terms, while difficult to precisely define, are well understood by those skilled in the art.

Although embodiments and examples presented in this document describe only the three above feedback mechanisms, that should not be construed to constrain the present invention to combinations of only those three mechanisms. Many other types of feedback may be employed in various embodiments and incorporated into the derivation of a performance index in a similar manner.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

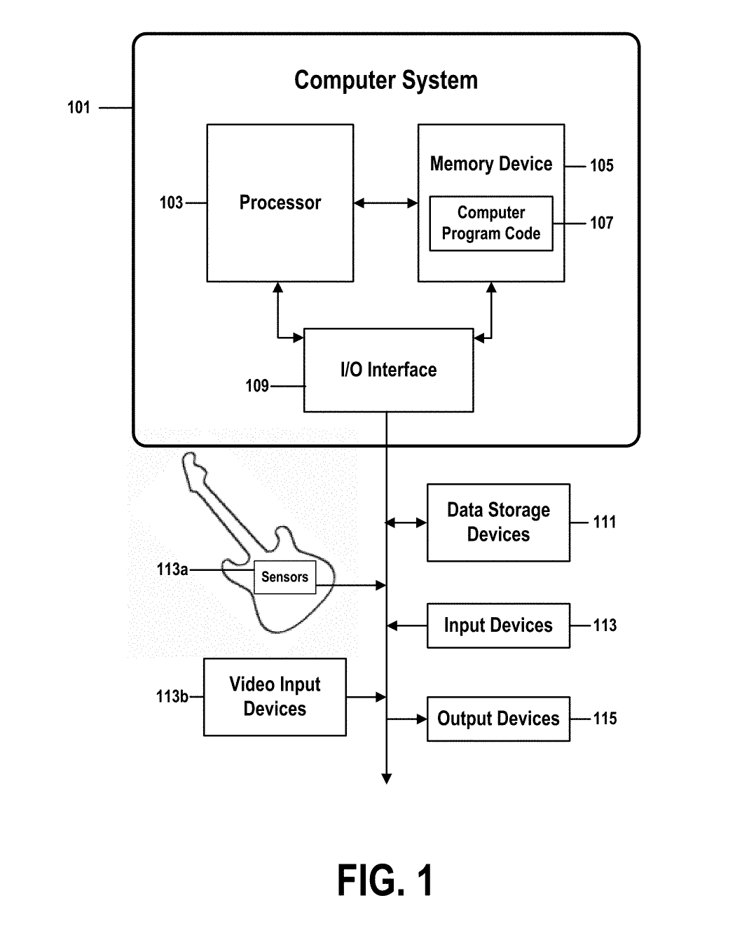

FIG. 1 shows a structure of a computer system and computer program code that may be used to implement a method for real-time analysis of a musical performance using analytics in accordance with embodiments of the present invention. FIG. 1 refers to objects 101-115.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

One class of input device 113 is an embedded sensor 113a, which may be embedded into any object capable of recording or detecting a parameter of a performance. For example, a MIDI, tactile, vibrational, ultrasonic, pressure-sensing, or infrared sensor 113a may be embedded into an electric or acoustic guitar, a piano or electronic keyboard, a microphone or speaker, a wind or brass instrument, or a set of drums. Such a sensor 113a might be capable of determining an exact timing, pitch, intonation, volume, or other parameter of a musical performance.

In another example, sensors 113a might comprise a set of stage microphone that detect relative volumes of each instrument or vocalists of an acoustic ensemble or a company of operatic singers and instrumentalists to determine if a performance's instrumental or vocal mix is balanced.

In other embodiments, another class of input device 113 might be a video camera, video-capture device, or still-image camera 113b capable of capturing body language, facial expression, or other involuntary behavioral characteristics of audience members. In some cases, such a visual-input device 113b may be configured to provide low-light response and a high enough resolution to enable accurate capture of audience facial expressions in a dimly lit auditorium. In larger venues, multiple devices 113b may be configured at various locations around the room in order to increase the likelihood that a statistically significant number of audience members can be viewed by a device 113b.

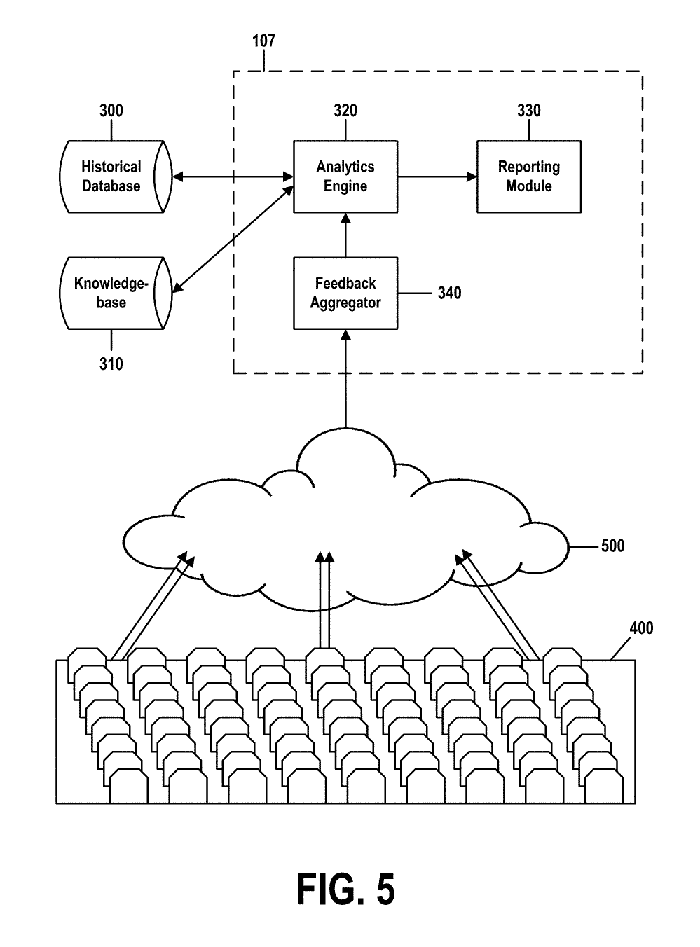

In addition to input devices 113, 113a, and 113b, the processor may receive other input that is forwarded to a software analytics engine by means of an I/O interface connected to the Internet, to a cloud-computing service, or to another network-attached resource. In an embodiment of FIG. 5, for example, the system may receive performance ratings from an Internet-based social-media network, where those ratings are continuously entered by audience members through personal or mobile computing devices.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for real-time analysis of a musical performance using analytics in accordance with embodiments of the present invention, and may implement other embodiments described in this specification, including the methods illustrated in FIGS. 1-5. The data storage devices 111 may store the computer program code 107. Computer program code 107 stored in the storage devices 111 is configured to be executed by processor 103 via the memory devices 105. Processor 103 executes the stored computer program code 107.

In some embodiments, rather than being stored and accessed from a hard drive, optical disc or other writeable, rewriteable, or removable hardware data-storage device 111, stored computer program code 107 may be stored on a static, nonremovable, read-only storage medium such as a Read-Only Memory (ROM) device 105, or may be accessed by processor 103 directly from such a static, nonremovable, read-only medium 105. Similarly, in some embodiments, stored computer program code 107 may be stored as computer-readable firmware 105, or may be accessed by processor 103 directly from such firmware 105, rather than from a more dynamic or removable hardware data-storage device 111, such as a hard drive or optical disc.

Thus the present invention discloses a process for supporting computer infrastructure, integrating, hosting, maintaining, and deploying computer-readable code into the computer system 101, wherein the code in combination with the computer system 101 is capable of performing a method for real-time analysis of a musical performance using analytics.

Any of the components of the present invention could be created, integrated, hosted, maintained, deployed, managed, serviced, supported, etc. by a service provider who offers to facilitate a method for real-time analysis of a musical performance using analytics. Thus the present invention discloses a process for deploying or integrating computing infrastructure, comprising integrating computer-readable code into the computer system 101, wherein the code in combination with the computer system 101 is capable of performing a method for real-time analysis of a musical performance using analytics.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise the computer-readable hardware storage device.

While it is understood that program code 107 for a method for real-time analysis of a musical performance using analytics may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for a method for real-time analysis of a musical performance using analytics is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

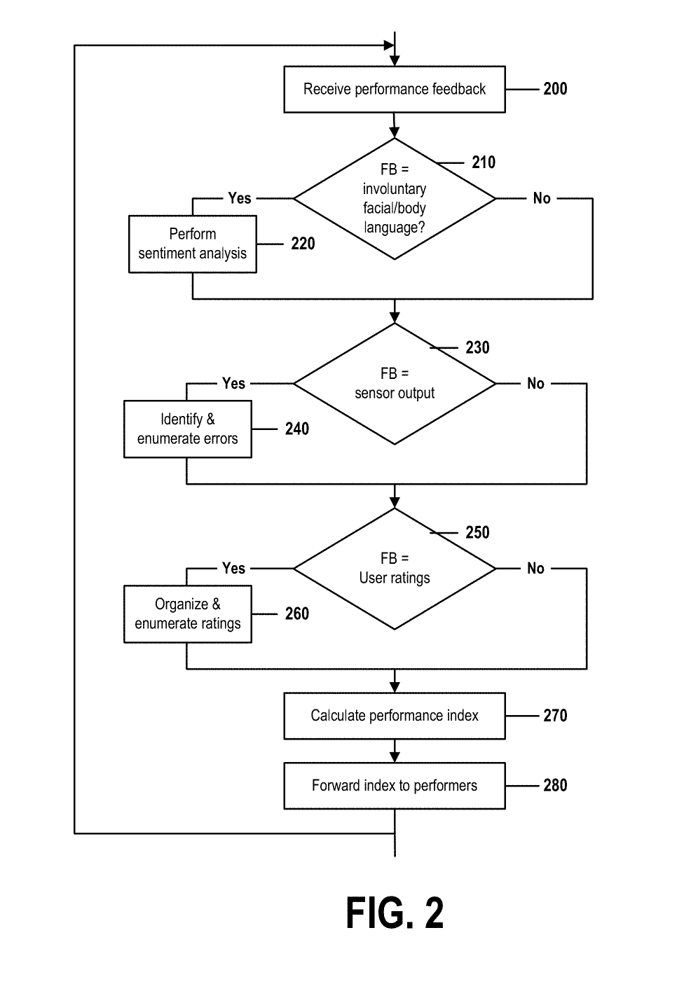

FIG. 2 is a flow chart that illustrates steps of a method for real-time analysis of a musical performance using analytics in accordance with embodiments of the present invention. FIG. 2 contains steps 200-280.

In step 200, a processor of a real-time performance-analysis system receives performance feedback that characterizes a characteristic of the performance. As described above, the processor may run computer program code 107 for performing real-time performance analysis, where the code 107 may include an artificially intelligent analytics engine 320, a feedback aggregator 340 (which receives incoming feedback), or a feedback-reporting module 330 or other type of communications software capable of notifying a performer of a semantic meaning inferred from the received feedback.

In embodiments and examples described in this document, this feedback may be received continuously, as from a persistent connection to a video camera or embedded sensor, or from a continually updated Internet Web site. In such cases, steps 200-280 may be performed repeatedly, as an iterative procedure, continuously receiving and analyzing feedback and providing near real-time performance analyses or recommendations to performers.

The system may also include a repository 300 of historical data or a knowledgebase 310, either or both of which may be used by the analytics engine to infer meaning from the received feedback. Such a repository 300 or knowledgebase 310 may store historical data, inference rules, and other data and knowledge required by the analytics engine to infer meaning to received feedback.

For example, in a performance rehearsal, the repository may comprise a copy of a score being rehearsed, and may use that score to determine when a practicing performer makes an error while playing the score. In another example, the repository may store historical data that identifies characteristics of past performances, where each performance may be a performance of the same score or by the same performer. The engine may then use this historical data to determine whether errors in the current performance meet or exceed average levels of errors in past performances.

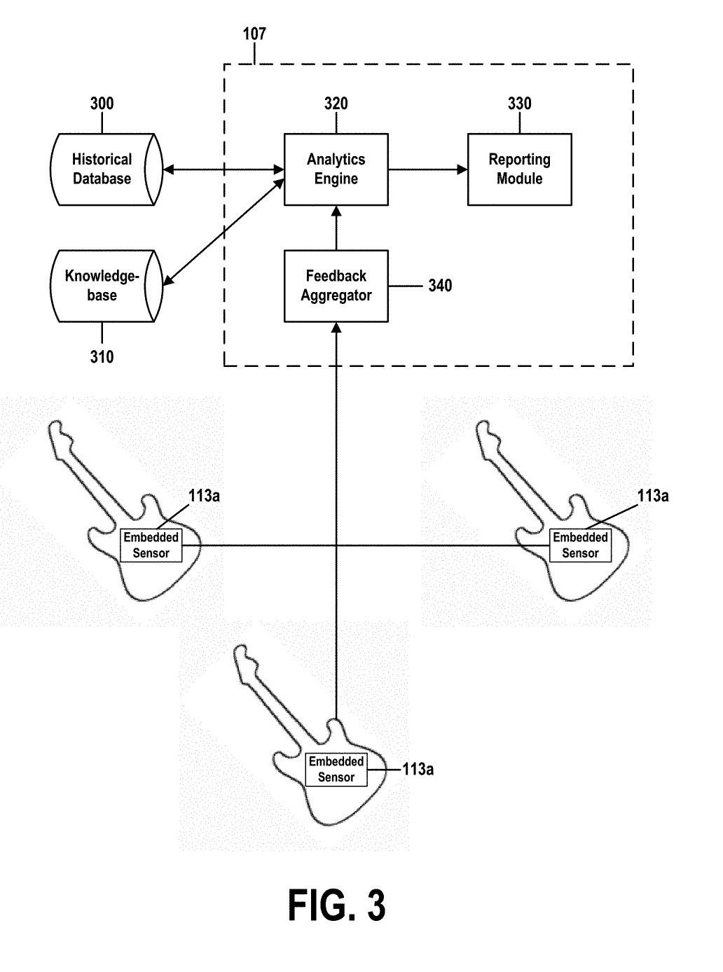

As described above and illustrated in the exemplary embodiments of FIGS. 3-5, this feedback may take numerous forms, such as objective performance data collected by one or more sensors embedded into musical instruments or other computerized, electronic, electric, or non-electric components of the performance; a visual representation of an audience member's facial expression or body language capable of being analyzed by an analytics program (such as a facial-recognition application) in order to infer semantic meaning to the audience member's expression or body language; or user feedback or performance ratings submitted to a network-based data-collection resource, such as an Internet or intranet Web site, a cloud service, or a custom network-based application.

In step 210, the processor determines whether the received feedback comprises visual representations of audience facial expressions, body language, or other involuntary behavior received from a video camera 113b, video-capture device 113b, or other type of device 113b that comprises a video-capture component. If the system determines that the feedback does include such representations, the method of FIG. 2 performs step 220.

In step 220, the processor performs a sentiment analysis upon the received visual data. Such artificially intelligent sentiment analyses are known in the art and may include a facial-recognition analysis or body-language recognition analysis that allows the processor to infer semantic meaning to an audience member's observable behavior. These analyses may further allow the processor to continue to identify specific audience members, so as to provide streams of sentiment inferences that are each associated with a particular audience member.

At the conclusion of step 220, the processor may have associated a sentiment or other emotional characteristic of at least one audience member. For example, it may have inferred from a first audience member's body language that the first audience member may be bored, or it may have inferred from a second audience member's smiling facial expression that the second audience member is enjoying the performance. By correlating these current sentiment inferences with sentiments previously inferred from those same members' previously detected body language or expression, the analytics engine may further refine its sentiment analysis to identify a trending emotional state that is becoming more prominent or less prominent during a specific period of time.

In step 230, the processor determines whether the received feedback comprises input from one or more sensors 113a that identify objective performance parameters, such as rhythmic precision, pitch accuracy, tempo, or volume levels. As described above, sensors 113a may comprise any technologies known in the art and may report any sort of performance metrics deemed significant by an implementer.

For example, in an opera performance, contact-pickup sensors 113a attached to one or more orchestral instruments may report the accuracy of each player's timing. In a dramatic presentation, lavalier-mic sensors 113a may report relative volume levels of each speaker. In a rock show, MIDI sensors 113a, pressure sensors 113a, or ultrasonic sensors 113a may report the pitch and metric accuracy of each musician.

If the system determines that the feedback does include such sensor output, the method of FIG. 2 performs step 240.

In step 240, the processor, by means of software techniques known in the art, identifies errors and other undesirable events in the received sensor feedback. In a music-rehearsal scenario, for example, sensors 113a embedded into an electronic keyboard might report the precise timing and amplitude of each note played on the keyboard. In some embodiments, this function may be further enhanced by the analytics engine's reference to a score or other transcription of the music being rehearsed. In such cases, the engine may identify performance errors by comparing the score to the actual performance reported by the sensor 113a.

In some cases, an electronic instrument or other component of a performance may already comprise integrated functionality that allows the instrument or component to produce similar feedback without requiring custom sensors 113a. For example, a MIDI guitar might already have the ability to output precise timing and amplitude (or “MIDI velocity”) data for each note played by a guitarist performer.

The analytics engine, by means of artificial intelligence known in the art, may use historical information stored in repository 300 and knowledge stored in the knowledgebase to infer other semantic meanings from the sensor input. For example, the engine may combine input received from multiple microphone-based sensors 113a to determine whether members of a vocal quartet are harmonizing properly. In another example, the engine may use historic, archived, or previously logged data stored in repository 300 to determine whether a tempo inferred from received sensor data has in the past been associated with negative audience reactions.

In step 250, the processor determines whether the received feedback comprises performance ratings or comments submitted by audience members to a network-based application, such as an Internet Web site, a social-media service, a smartphone app, or a network-resident proprietary feedback-tracking application. These ratings and comments may be submitted to a tracking mechanism by any means known in the art, such as through a cellular network from a cell phone, or via a wireless Internet connection.

In embodiments that include this functionality, the processor may receive this feedback through I/O interface 109 or through any other network interface accessible to the processor.

If the processor determines that the feedback does include such ratings or comments, the method of FIG. 2 performs step 260.

In step 260, the processor organizes and enumerates the received ratings or comments. For example, if the received ratings or comments include Facebook “Likes” and “Dislikes,” the processor in this step might count the number of Likes and the number of Dislikes, might add the current numbers of Likes and Dislikes to previously received Likes and Dislikes received during a certain span of time, or may aggregate the received Likes and Dislikes with other positive or negative ratings submitted by audience members to other social networks. In some embodiments, only the positive or only the negative ratings may be stored, and in other embodiments, the processor may convert the numbers of positive or negative ratings into a percent value, a numeric decimal value, or a ratio.

In step 270, the processor generates an alphanumeric or numeric performance index as a function of the results of the analyses, enumerations, and identifications performed in steps 220, 240, and 260.

Not all embodiments will continuously receive all three types of feedback described in FIG. 2, and even those embodiments that are capable of receiving all three types may not receive all three during a single iteration of the iterative procedure of steps 200-280. Furthermore, other embodiments not shown in this figure may receive other types of real-time performance feedback through other means. Embodiments of the present invention are flexible enough to incorporate any of these possibilities, so long as the feedback received during any particular iteration is capable of being processed, through either arithmetic or analytics methods, into numeric values that may be used to calculate a performance index.

In the example of FIG. 2, if all three types of feedback are received, the performance index may most simply computed as an average of positive characterizations of the performance inferred from the received feedback.

In one example, received feedback may comprise positive and negative Twitter tweets, Facebook Likes and Dislikes, visual records of audience members' facial expressions and body language, and objective performance pitch, velocity, and timing information derived from MIDI sensors embedded into each performer's instrument.

Here, the analytics engine may assign a relative numeric value to a sentiment analysis that infers an audience member's emotional state from his or her facial expression or body language. For example, a rating in the range of 1-10 may be used to rank different possible inferred emotions from 1 (least desirable) to 10 (most desirable). Similarly, the engine may further assign a numeric value to the objective accuracy of the performance by determining how closely the performance conforms to a known written score.

The exact numeric values, scaling, and ranges of these numeric values are not important to the present invention, which is flexible enough to accommodate an sort of value range desired by an implementer. In one example, each calculated parameter may be normalized to fall within an inclusive range of 0.0 through 1.0 and a number of positive ratings may be scaled such that any number of ratings that falls within an expected range is normalized to an inclusive range from 0.0 through 1.0. If an implementer desires to present the performance index in another way, other ranges and scaling methods may be selected at will by an implementer.

In the current example, a performance index PI may be calculated as:

PI=# positive tweets+# positive FB Likes+facial sentiment+body-language sentiment+objective-performance accuracy rating

In this equation:
“# positive tweets” is the number of positive feedback items submitted by audience members to Twitter since the previous iteration of the procedure of steps 200-280.
“# positive FB Likes” is the number of “Likes” submitted by audience members to Facebook since the previous iteration of the procedure of steps 200-280.
“facial sentiment” may be a numeric representation of the desirability of an audience emotional state inferred from facial-expression visual feedback received in step 200 and analyzed in step 220. For example, if an emotional state of “bored” is inferred from a frowning facial expression, that state might be associated with a facial-sentiment value of 0.2. But a more positive state of “happy,” inferred from a smiling expression, might have a higher facial-sentiment value of 0.9. In this example, a higher value represents a more desirable sentiment, but the present invention may, if desired by an implementer, employ a scale in which a higher value represents a less desirable sentiment.
“body language sentiment” may be a numeric representation of the desirability of an audience emotional state inferred from body-language visual feedback received in step 200 and analyzed in step 220. For example, if an emotional state of “impatient” is inferred from an audience member's hand movements, that state might be associated with a body language-sentiment value of 0.4. But a more positive sentiment may be inferred from an audience member who is rocking in time with the music, yielding a higher body language-sentiment value of 0.9. As with facial sentiment values, the present invention may, if desired by an implementer, employ a scale in which a higher value represents a less desirable sentiment
“objective-performance accuracy rating” is a numeric representation of an accuracy of a performance as reported by one or more embedded sensors 113a. As with the above sentiment values, this rating may be represented by any means desired by an implementer, as a function of the analytics engine's analysis of sensor input received in step 200. For example, if performers are most concerned about playing the correct notes, the engine may derive a rating as a function a ratio between correct and incorrect pitches, normalized to fall within the range of 0 through 100, inclusive.

In embodiments where some or all of these parameters may be derived for multiple audience members the above equation sums all the parametric values for each audience member as above and then averages each member's sum to produce a single value. That single value may be normalized to fall within a specific range.

Although the performance index described above is calculated as a function of positive inferences, other embodiments may just as easily calculate the performance index as a function of negative inferences, such as a number or percent of tweets that are determined by the analytics engine to express a negative sentiment. In yet other embodiments, a performance index may be derived as a ratio or difference between numbers of positive sentiments and negative sentiments.

In some cases, a performance index may be derived as a function of parameters specific to particular audience members (such as facial sentiment) and of parameters that are specific to particular performers (such as the objective-performance accuracy rating). In such cases, if a goal of the implementation is to gauge audience response to a complete performance, a single objective-performance accuracy rating may be derived for each performer and then averaged to produce a single objective-performance accuracy rating that is used to derive every audience member's PI.

If, on the other hand, a goal of the implementation is to gauge audience response to one or more individual performers, a objective-performance accuracy rating may be derived for each performer. In such a case, a separate PI may be derived for each combination of performer and audience member.

For example, if three performers play to 100 audience members, 300 performance indices may be computed, one for each distinct combination of audience member and performer. Each performer's 100 PIs may then be averaged to generate three resulting performance indices, one for each performer.

In embodiments that comprise additional types of feedback, similar numeric values may be straightforwardly entered into the above PI-calculation equation. Similarly, if step 210, 230, or 250 determine that one or more of the three possible types of feedback described here have not been received since the previous iteration of the procedure of steps 200-280, then parameters corresponding to the omitted types of feedback would be omitted from all performance-index calculations performed during the current iteration.

In step 280, the processor reports the performance index in real-time to the one or more performance by any means known in the art. The reporting may, for example, comprise displaying an animated time-varying graph of the performance value as it changes over time, due to repeated performances of the iterative procedure of steps 200-280. This provides near-instantaneous graphical feedback about audience responses that a performer may monitor without undue distraction.

In other examples, the reporting may consist of a display of a numeric representation of a performance index, optionally scaled to any desired range, such as a range from 0.0 through 1.0 or a range from 1 through 1000. In some embodiments, a performer may have the option of interactively scaling the display in real time by means of a mouse, tablet, or other known input device. In other cases, as described above, the reporting may comprise illuminating or changing the color of an LED indicator, providing tactile or haptic feedback, or displaying an animated bar chart, two-dimensional or three-dimensional graph of selected parameters, or by representing a performance index or any of the parameters from which the index is derived in other graphical formats.

Some embodiments may accommodate a practicing performer, such as a rehearsing musician, by displaying a score of the musical selection that is being practiced. In some cases, the system may concurrently display the score along with the actual notes played by the performer, as a way to allow the performer to interactively view, in real time, discrepancies between the score and the performance.

As described above, some embodiments may report other information derived by the analytics engine. For example, the processor may name an inferred audience sentiment, such as “uninterested” or “happy” or may represent an emotional state in a graphical manner, such as an icon positioned along a scale that ranges between most desirable sentiments and most undesirable sentiments.

Some embodiments may further recommend mitigating actions deemed by the analytics engine to be likely to mitigate negative audience response. For example, if the engine determines, by using knowledge and rules stored in the knowledgebase to interpret historic data (which may include recently gathered feedback generated in response to the current performance), that certain audience members began losing interest at about the time a bass solo began, the system may recommend that the bass player quickly end the solo or alter an aspect of the bass solo that has correlated to undesirable audience reactions during previous performances of the same composition.

Many other examples are possible, but all embodiments will provide real-time or near real-time feedback to a performer that is based on a combination of one or more of: real-time capture and analysis of involuntary audience behavior; audience-entered ratings and comments; and real-time capture of sensor-derived objective performance statistics.

FIG. 3 illustrates an architecture of an embodiment of the present invention in which analytics engine 320 receives real-time objective performance data from sensors embedded in musical instruments. FIG. 3 comprises items 107, 113a, and 300-340.

Item 107 is identical in form and function to the identically numbered item of FIG. 1, which represents computer code for performing steps of the present invention. This computer code performs functions of an analytics engine 320, a reporting module 330, and a feedback aggregator 340.

Feedback aggregator 340 receives incoming feedback via I/O interface 109 from sources like sensors 113a, a remote application that receives performance ratings from audience members, or video input devices 113b. Aggregator 340 organizes and sorts incoming data as required and submits the organized data to the analytics engine 320. Aggregator 340 may perform these operations by any method known in the art.

Operations of the analytics engine 320 were described in depth in FIG. 2. This engine performs artificially intelligent operations known in the art capable of inferring semantic meaning from input received from feedback aggregator 340.

Analytics engine 320 performs its analysis and generates inferences through methods and technologies known in the field of artificial intelligence. As is known in the art analytics engine 320 may perform these operations as a function of knowledge, concepts, ontologies, or rules stored in knowledgebase 310 and of archived historical information stored in historical database 300. As described in FIG. 2, the archived historical information may comprise data logged by earlier iterations of the present invention during previous performances. This archived information may include performance characteristics, received audience responses, semantic meanings inferred from the audience responses, and mitigating actions recommended by the system.

Reporting module 330 is a straightforward data-output application that forwards the output of analytics engine 320 to one or more external components each capable of communicating with a performer.

In a typical operation of the embodiment of FIG. 3, performances of a set of musicians (or other types of performers) are captured by sensors 113a embedded into, or in proximity to, each musical instrument, vocalist, microphone, or other performance-content source. The sensors 113a report performance characteristics in real time to the feedback aggregator 340. If necessary, the aggregator 340 may organize the incoming raw data into a form that may be submitted to analytics engine 320.

For example, if two guitarists, a bassist, a kit drummer, and two vocalists each generate a stream of performance data by means of six sensors 113a respectively, each received element of data may be transmitted to aggregator 340 in chronological order. In such a case, aggregator 340 might then sort the input into six streams, one for each performer, before submitting the data to analytics engine 320.

In other embodiments, feedback aggregator 340 may perform other interfacing, filtering, or data-preparation operations, as required by an embodiment's particular configuration of input-generating sources. Aggregator 340 may, for example, reformat incoming data to conform to a particular numeric data format or may tag each type of incoming data to identify that the incoming data was received from a particular instrument or to identify that an incoming data element was received from a particular type of input source or belongs to a certain class of data objects, such as a still image of a facial expression, a video stream of an audience member's body language, an element of MIDI note-velocity data, time-stamped note-timing data, a sound-pressure level, a natural-language text comment, or an audience-submitted performance rating.

The analytics engine 320 then, using methods of analytics known in the art, collects and analyzes each logical stream of incoming data. This analysis function may be performed as a function of knowledge stored in knowledgebase 310 or of historical performance data stored in historical database 300.

In this way, analytics engine 320 or reporting module 330 may generate one or more performance indices that represent an overall quality of, a specific characteristic of, or an audience reaction to, the overall performance or the individual performances of one or more individual performers. Analytics engine 320 may also, by means known in the art, generate a recommendation for improving an overall quality of a performance or for mitigating an undesirable audience response.

The reporting module 330, upon receiving or generating this information, then communicates the performance indices, recommendations, or another representation of the analytics engine 320's output by means of methods described in step 280 of FIG. 2.

In some embodiments, as described in FIG. 2, the architecture of FIG. 3 may be implemented in a rehearsal setting, where one or more performers are practicing a performance of a musical, visual, dramatic, or other type of performance. The method of FIG. 3 may be used in such cases to provide real-time feedback when a performer makes an error or otherwise does not perform in a desired manner.

In the case of musical rehearsals, the system of FIG. 3 may be thus extended to display a musical score or transcription of the musical composition to be performed, allowing the system to identify in real-time when an element of the performance, such as a note or chord, is played in a manner that does not match the score or transcription. This feature may be implemented by storing the musical score in historical database 300 or knowledgebase 310, in order to make the score available to analytics engine 320 or reporting module 330.

In certain embodiments, this procedure is performed quickly enough to provide real-time or near real-time feedback to the performers. If, for example, one guitarist has begun playing in the wrong key because he cannot hear the other performers, the system might flash an LED indicator on the guitarist's instrument within a very brief period of time (ideally, less than a second, but preferably less than five seconds) after the analytics engine 320 receives enough sensor data to determine that the guitarist, rather than merely playing a few wrong notes, is actually playing in the wrong key.

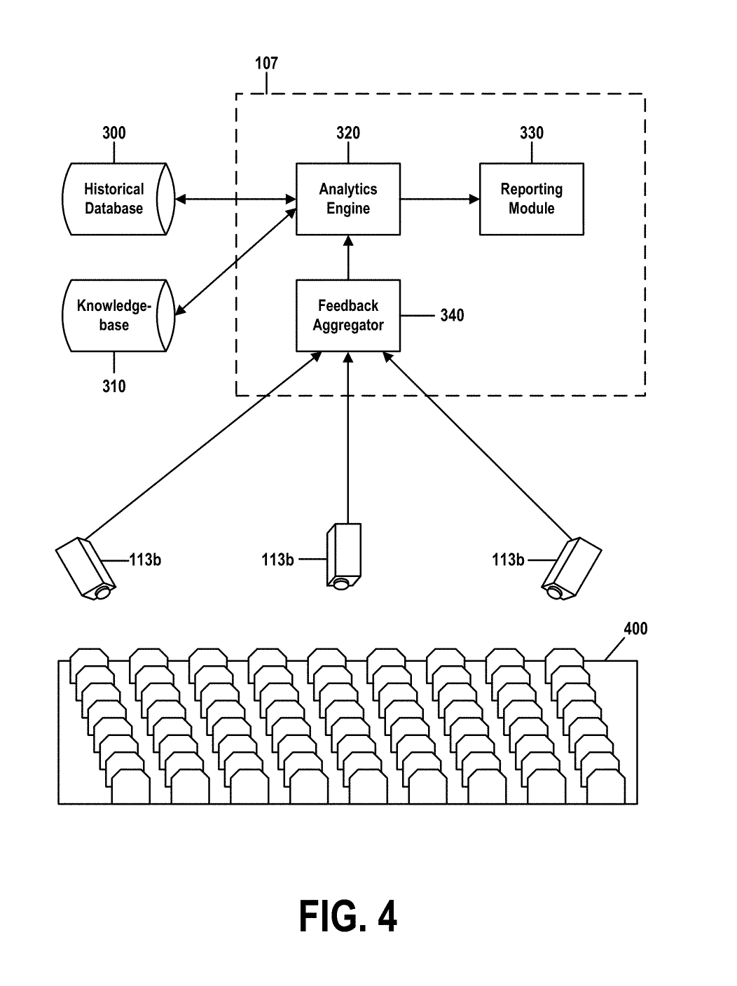

FIG. 4 illustrates an architecture of an embodiment of the present invention in which analytics engine 320 receives real-time visual data representing body language or facial expressions of audience members. FIG. 4 shows items 107, 113b, 300-340, and 400.

Items 107 and 300-340 are similar in form and function to identically numbered items of FIG. 3. Video devices 113b, as described in FIG. 1, may be any sort of device capable of capturing moving video or still images of an audience member's involuntary body language or facial expression. In some embodiments, video devices 113b may be configured with zoom lenses or motorized mounts that allow the video devices 113b to select individual audience members or groups of audience members to record.

Item 400 represents the entire audience to the performance being analyzed.

Like FIG. 3, FIG. 4 represents an exemplary embodiment of the present invention in which feedback aggregator 340 receives raw-data input that identifies a characteristic of a performance or of an audience's response to the performance. That raw data is then processed by aggregator 340 and analytics engine 320 to produce output that is communicated to one or more performers by reporting module 330.

In FIG. 4, the raw data is produced by video input devices 113b, which record facial expressions, body language, or other visually identifiable indicators of audience members' reactions to the performance. As in the embodiment of FIG. 3, this incoming data may be organized or tagged by the feedback aggregator 340 into a form suitable for submission to analytics engine 320.

Also as in FIG. 3, the analytics engine 320, using facial-recognition or body-language recognition methods known in the art, may associate each incoming data element or data stream with a particular audience member or group of audience members. Using rules, concepts, and other information stored in knowledgebase 310, and optionally using historical performance data stored in historical database 300, the analytics engine 320, in conjunction with reporting module 330, may generate and communicate to the performers a visual, audio, graphical, textual, or other real-time characterization of the quality of the current performance or of the audience's current reaction to the performance. This procedure should strive to provide feedback to performers with a response time that approximates real-time response.

FIG. 5 illustrates an architecture of an embodiment of the present invention in which the analytics engine 320 receives real-time ratings of a performance submitted by audience members through personal computing devices. FIG. 5 shows items 107, 300-340, 400, and 500.

Items 107, 300-340, and 400 are similar in form and function to identically numbered items of FIG. 4.

Item 500 represents a network capable of receiving audience feedback submitted by means of audience members' mobile or personal, and either tethered or wireless, computing devices. Network 500 may be any network known in the art, such as a wireless or cabled Ethernet network, the Internet, an intranet, a private wireless network, an SMS-capable network, or a cellular network.

Like FIG. 4, FIG. 5 represents an exemplary embodiment of the present invention in which feedback aggregator 340 receives raw-data input that identifies a characteristic of a performance or of an audience's response to the performance. That raw data is then processed by aggregator 340 and analytics engine 320 to produce output that is communicated to one or more performers by reporting module 330.

In FIG. 5, the raw data is in the form of performance ratings, comments, favorability indicators (such as “likes,” “dislikes,” or star ratings), or other indicators of an audience's opinion of the performance. This data may be entered repeatedly throughout the course of the performance as audience members' reactions to specific segments of the performance vary. In some embodiments, the data may be entered at any time during the performance, according to the preference of each audience member, and immediately transferred via network 500 to a rating-receiving entity, such as a Web site, a social-media network, a reserved online account, or a network-attached proprietary software application comprised by the embodiment.

As in the embodiment of FIGS. 3 and 4, the incoming data may be received, organized, or tagged by the feedback aggregator 340 into a form suitable for submission to analytics engine 320. For example, the aggregator 340 may sort incoming ratings into groups organized by specific supported sources (such as Twitter or Facebook). In some embodiments, aggregator 340 may organize some or all incoming data items by the class or category of each item. In such embodiments, the aggregator 340 may group social-media likes and dislikes into one category, numeric ratings received through a proprietary application in a second category, and natural-language text comments in a third category.

As in FIGS. 3 and 4, the analytics engine 320 may use knowledgebase 310 and historical database 300 to associate each incoming data element or data stream with a particular audience member or group of audience members. The analytics engine 320 may then, in conjunction with reporting module 330, interpret the output of feedback aggregator 340 to generate and communicate to the performers a visual, audio, graphical, textual, or other real-time characterization of the quality of the current performance or of the audience's current reaction to the performance.

As described above, this procedure should strive to provide feedback to performers with a response time that approximates real-time response. In all cases, the response time should be short enough to allow performers to adjust an attribute of the performance quickly enough to mitigate any undesirable audience reaction reported by the system.

What is claimed is:

1. A performance-analysis system comprising a processor, a memory coupled to the processor, one or more sensors coupled to the processor and embedded into musical instruments used by performers of a musical performance, a network interface that connects the processor to a computer network, and a computer-readable hardware storage device coupled to the processor, the storage device containing program code configured to be run by the processor via the memory to implement a method for analysis of a musical performance using analytics, the method comprising:
the processor electronically receiving feedback characterizing an ongoing musical performance by one or more performers;
the processor inferring a characteristic of the performance by using an artificially intelligent analytics procedure to analyze the feedback,
where the analytics procedure is a function of a repository of archived information about past performances by the one or more performers and of a knowledgebase from which the feedback may be given semantic meaning, and
where the inferred characteristic is considered undesirable by the one or more performers; and
the processor communicating the inferred characteristic to the one or more performers for the purpose of allowing the one or more performers to alter their ongoing performance in order to mitigate undesirability of the inferred characteristic.

2. The system of claim 1,
where the feedback comprises an electronic record of the ongoing performance recorded by the sensors during the ongoing performance.

3. The system of claim 1,
where the feedback comprises a performance rating submitted by an audience member through a personal communications device to an Internet-based service, and
where the performance rating is received by the processor through the network interface.

4. The system of claim 1,
where the feedback comprises a visual identification of involuntary behavior of the audience, and
where the inferring comprises performing an analytics-based sentiment analysis upon the visual identification.

5. The system of claim 4, where the involuntary behavior comprises at least one audience member's body language and facial expressions.

6. The system of claim 1,
where the feedback comprises:
an electronic record of the ongoing performance recorded by the sensors during the ongoing performance,
a set of performance ratings submitted by at least one audience member through a personal communications device to an Internet-based service, and
a visual identification of at least one audience member's body language and facial expressions, and
where the inferring comprises:
performing an analytics-based sentiment analysis upon the visually identified body language and facial expressions, and
computing a numeric performance index as a function of:
a percent of the set of performance ratings that indicate an undesirable audience reaction,
a percent of sentiments identified by the sentiment analysis that indicate an undesirable audience reaction, and
a percent of notes played incorrectly by a performer of the one or more performers.

7. The system of claim 1,
where the performance is a practice exercise,
where the feedback comprises an electronic record of the ongoing performance recorded by the sensors during the ongoing performance, and
where the characteristic is an inaccurate playing of a note of a musical score.

8. The system of claim 1,
where the inferring further comprises a determination that a modification to the performance of at least one performer of the one or more performers during the remainder of the ongoing performance is likely to mitigate the undesirability of the characteristic, and
where the communicating comprises recommending the modification to the at least one performer.

9. A method for analysis of a musical performance using analytics, the method comprising:
a processor of a performance-analysis system electronically receiving feedback characterizing an ongoing musical performance by one or more performers;
the processor inferring a characteristic of the performance by using an artificially intelligent analytics procedure to analyze the feedback,
where the analytics procedure is a function of a repository of archived information about past performances by the one or more performers and of a knowledgebase from which the feedback may be given semantic meaning,
where the inferred characteristic is considered undesirable by the one or more performers, and
where the inferring further comprises a determination that a modification to the performance of at least one performer of the one or more performers during the remainder of the ongoing performance is likely to mitigate the undesirability of the characteristic; and
the processor communicating the inferred characteristic to the one or more performers for the purpose of allowing the one or more performers to alter their ongoing performance in order to mitigate undesirability of the inferred characteristic,
where the communicating comprises recommending the modification to the at least one performer.

10. The method of claim 9,
where the feedback comprises an electronic record of the ongoing performance recorded during the ongoing performance by one or more sensors coupled to the processor and embedded into musical instruments used by performers.

11. The method of claim 9,
where the feedback comprises a performance rating submitted by an audience member through a personal communications device to an Internet-based service, and
where the performance rating is received by the processor through a network interface.

12. The method of claim 9,
where the feedback comprises a visual identification of at least one audience member's body language and facial expressions, and
where the inferring comprises performing an analytics-based sentiment analysis upon the visual identification.

13. The method of claim 9,
where the feedback comprises:
an electronic record of the ongoing performance recorded during the ongoing performance by one or more sensors coupled to the processor and embedded into musical instruments used by performers,
a set of performance ratings submitted by at least one audience member through a personal communications device to an Internet-based service, and
a visual identification of at least one audience member's body language and facial expressions, and
where the inferring comprises:
performing an analytics-based sentiment analysis upon the visually identified body language and facial expressions, and
computing a numeric performance index as a function of:
a percent of the set of performance ratings that indicate an undesirable audience reaction,
a percent of sentiments identified by the sentiment analysis that indicate an undesirable audience reaction, and
a percent of notes played incorrectly by a performer of the one or more performers.

14. The method of claim 9,
where the performance is a practice exercise,
where the feedback comprises an electronic record of the ongoing performance recorded by the sensors during the ongoing performance, and
where the characteristic is an inaccurate playing of a note of a musical score.

15. The method of claim 9, further comprising providing at least one support service for at least one of creating, integrating, hosting, maintaining, and deploying computer-readable program code in the computer system, wherein the computer-readable program code in combination with the computer system is configured to implement the receiving, the inferring, and the communication.

16. A computer program product, comprising a computer-readable hardware storage device having a computer-readable program code stored therein, the program code configured to be executed by a performance-analysis system comprising a processor, a memory coupled to the processor, one or more sensors coupled to the processor and embedded into musical instruments used by performers of a musical performance, a network interface that connects the processor to a computer network, and a computer-readable hardware storage device coupled to the processor, the storage device containing program code configured to be run by the processor via the memory to implement a method for analysis of a musical performance using analytics, the method comprising:
the processor electronically receiving feedback characterizing an ongoing musical performance by one or more performers;
the processor inferring a characteristic of the performance by using an artificially intelligent analytics procedure to analyze the feedback,
where the analytics procedure is a function of a repository of archived information about past performances by the one or more performers and of a knowledgebase from which the feedback may be given semantic meaning, and
where the inferred characteristic is considered undesirable by the one or more performers, and
where the inferring further comprises a determination that a modification to the performance of at least one performer of the one or more performers during the remainder of the ongoing performance is likely to mitigate the undesirability of the characteristic; and
the processor communicating the inferred characteristic to the one or more performers for the purpose of allowing the one or more performers to alter their ongoing performance in order to mitigate undesirability of the inferred characteristic,
where the communicating comprises recommending the modification to the at least one performer.

17. The computer program product of claim 16,
where the feedback comprises an electronic record of the ongoing performance recorded during the ongoing performance by one or more sensors coupled to the processor and embedded into musical instruments used by performers.

18. The computer program product of claim 16,
where the feedback comprises a performance rating submitted by an audience member through a personal communications device to an Internet-based service, and
where the performance rating is received by the processor through a network interface.

19. The computer program product of claim 16,
where the feedback comprises a visual identification of at least one audience member's body language and facial expressions, and
where the inferring comprises performing an analytics-based sentiment analysis upon the visual identification.

20. The computer program product of claim 16,
where the feedback comprises:
an electronic record of the ongoing performance recorded during the ongoing performance by one or more sensors coupled to the processor and embedded into musical instruments used by performers,
a set of performance ratings submitted by at least one audience member through a personal communications device to an Internet-based service, and
a visual identification of at least one audience member's body language and facial expressions, and
where the inferring comprises:
performing an analytics-based sentiment analysis upon the visually identified body language and facial expressions, and
computing a numeric performance index as a function of:
a percent of the set of performance ratings that indicate an undesirable audience reaction,
a percent of sentiments identified by the sentiment analysis that indicate an undesirable audience reaction, and
a percent of notes played incorrectly by a performer of the one or more performers.
